(19) United States
(12) Patent Application Publication
(10) Pub. No.: US 2025/0211813 A1
(43) Pub. Date: Jun. 26, 2025

(54) METHOD OF STREAMING SYNCHRONIZED AUDIO OVER A NETWORK

(71) Applicant: Nexus Audio Visual Pty Ltd, East Victoria (AU)

(72) Inventor: Aran Francis Gallagher, Victoria (AU)

(73) Assignee: Nexus Audio Visual Pty Ltd, East Victoria (AU)

(21) Appl. No.: 19/077,838

(22) Filed: Mar. 12, 2025

Related U.S. Application Data
(63) Continuation of application No. PCT/AU2023/050879, filed on Sep. 12, 2023.

(30) Foreign Application Priority Data
Sep. 12, 2022 (AU) 2022902628

(51) Int. Cl. H04N 21/43; H04J 3/06; H04L 65/612

(52) U.S. Cl. CPC H04N 21/4307; H04J 3/0632; H04L 65/612

(57) ABSTRACT

A method of streaming synchronized audio over a network using asynchronous clock reconstruction from the sourcing audio including the steps of: an originating audio processor and a plurality of receiving audio processors for receiving transmitted sourced audio from the originating audio processor over an audio data transmission channel; processing sourced audio at the originating audio processor at a known source frequency; processing received transmitted sourced audio at the plurality of receiving audio processors at a changeable receiver frequency; wherein the changeable receiver frequency is determined by a combination of the known source frequency and an observation of the received transmitted sourced audio at the plurality of receiving audio processors.

### CROSS-REFERENCE TO RELATED PATENT APPLICATIONS

This Patent Application is a Continuation of co-pending Australian PCT Patent Application No. PCT/AU2023/050879, filed Sep. 12, 2023, which designated the United States and is now pending. This Patent Application and Australian PCT Patent Application No. PCT/AU2023/050879 claim priority to Australian Patent Application No. 2022902628, filed Sep. 12, 2022. The entire teachings and disclosure each application are incorporated herein by reference thereto.

### FIELD OF THE INVENTION

The present invention relates to a method of synchronized audio over a network. and in particular to a method of synchronized audio with low latency and low jitter over a network.

The invention has been developed primarily for use with audio signals transmitted between distant and/or different types of audio receiver/transmission systems streamed under one medium and then transmitted via ethernet to be played by a receiver/player and will be described hereinafter with reference to this application. However, it will be appreciated that the invention is not limited to this particular field of use.

### BACKGROUND OF THE INVENTION

There is a fundamental problem in maintaining synchronized audio clocks between a transmitted audio stream and a received audio stream over a network. Accurate clock synchronization is required to provide low jitter and low latency of an audio stream transmitted over the network.

As shown in FIG. 1 there are various cases where an audio streaming is produced such as on television, 131, a streaming channel 132, or streamings playable on record players, CD players or radios 133 and then through receiving transmission boxes TX fed into transmission network 135 such as a WiFi or other Wireless or wired Ethernet Network Fabric to a receiver RX that allows playing of transmitted streamed audio on self-contained audio system such as a multichannel Digital Signal Processor (DSP) Amplifiers 141, networked audio receivers 142 and stereo amplifier receivers feeding to own speaker network 143.

In another form it is required to have the transmission TX connected directly to the receiver RX without the use of a connecting network.

It is known to approach these problems by use of a method of facilitating clock synchronization over networks using PTP (Precision Time Protocol).

The PTP solution can include having a SYNC message and a DELAY message of a PTP clock synchronization cycle being carried by different redundant networks, and adjusting a timestamp associated with one of the messages to emulate transfer of the SYNC and the DELAY messages as if by the same redundant network.

There can be various ways of facilitating PTP clock synchronization. A network need not be a redundant (secondary) network for PTP to function for carrying messages from a slave clock to a master clock.

This requirement for linking slave clock and master clock or other uses of different forms of a “global clock” is an added complexity and further a limitation to operation in many streaming situations.

It can be seen that known prior art methods of streaming of synchronized audio over a network has the problems of:
a) Use of PTP clock is often complex and can require hardware support in the infrastructure, as well as configuration of the system to support it which is a distinct limitation;
b) Many complex state-of-the art standards for streaming audio cannot be implemented for a multitude of use cases due to a major limitation in that it defines a clocking system based on a single global PTP clock;
c) Using a single global Audio clock for distribution of compressed, or bit-perfect non-compressed audio results in a system that is only able to support a single input at any one time. This is a major limitation.
d) To keep cost low it is advantageous to use internal PLL within a microprocessor as the rate-controlled clock. Processors with glitch-less frequency changeable PLLs are not readily available. Processors with multiple PLLs are common.

The present invention seeks to provide a method of synchronized audio over a network, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a method of synchronized audio over a network using asynchronous clock reconstruction from audio sources including the steps of:
a) An audio data transmission channel between an originating audio processor and a receiving audio processor
b) A rate control of the audio data transmission channel providing a time correction to enable clock synchronisation of the processing of the audio on the originating audio processor with the audio on the receiving audio processor.

The audio data transmission channel can be a wireless channel such as WiFi or a wired channel such as ethernet.

In a further aspect of the invention there is provided a method of streaming synchronized audio over a network using asynchronous clock reconstruction from the sourcing audio including the steps of:
an originating audio processor and a receiving audio processor for receiving transmitted sourced audio from the originating audio processor over an audio data transmission channel;
processing sourced audio at the originating audio processor at a known source frequency;
processing received transmitted sourced audio at the receiving audio processor at a changeable receiver frequency;
   wherein the changeable receiver frequency is determined by a combination of the known source frequency and an observation of the received transmitted sourced audio at the receiving audio processor.

The processing received transmitted sourced audio is at the changeable receiver frequency.

The changeable receiver frequency is determined from the known source frequency and an observation of the IP packets of the received transmitted sourced audio in the buffer of the receiving audio processor.

The observation of the IP packets of the received transmitted sourced audio in the buffer of the receiving audio processor can be an indirect frequency correction of the known source frequency. This indirect frequency correction in one form includes observing a position of the buffer and counting the number of IP packets in the buffer to that point and particularly observing a particular value such as 50% of the size of PBS (Packet Buffer with Size) such that it can be determined that the corrected frequency is higher or lower than the known source frequency whereby the frequency of streaming is indirectly provided by the observation.

The observation of the IP packets of the received transmitted sourced audio in the buffer of the receiving audio processor can be a direct frequency correction of the known source frequency. This direct frequency correction in one form can include monitoring a particular marking on the sourcing audio and maintaining observation of the frequency of observation of consecutive markings. The direct frequency correction can include timestamps included in received packets which delivers the information on departure times of packets such that the corresponding arrival time is measured with a receiver clock whose frequency is thereby directly determinable. It can include timestamps, but may also be done without using received packet timestamps and instead from measuring arrival time without timestamps.

The observation of the IP packets of the received transmitted sourced audio in the buffer of the receiving audio processor can be a combination of direct and indirect frequency correction of the known source frequency.

For emergency actions, watermarks can be created near the high and low end of the IP packet buffer, and if the number of IP packets is detected to be near the watermarks then a more severe emergency frequency correction is undertaken so as to allow for emergency recovery back to the predetermined correct position such as at 50% of PBS.

In a further aspect of the invention there is provided a method of streaming synchronized audio over a network using asynchronous clock reconstruction from the sourcing audio including the steps of:
an originating audio processor and a plurality of receiving audio processors for receiving transmitted sourced audio from the originating audio processor over an audio data transmission channel;
processing sourced audio at the originating audio processor at a known source frequency;
processing received transmitted sourced audio at the plurality of receiving audio processors at a changeable receiver frequency;
   wherein the changeable receiver frequency is determined by a combination of the known source frequency and an observation of the received transmitted sourced audio at the plurality of receiving audio processors.

The processing received transmitted sourced audio is at the changeable receiver frequency.

The changeable receiver frequency is determined from the known source frequency and an observation of the IP packets of the received transmitted sourced audio in the buffer of the plurality of receiving audio processors.

The observation of the IP packets of the received transmitted sourced audio in the buffers of the plurality of receiving audio processors can be an indirect frequency correction of the known source frequency. This indirect frequency correction in one form includes observing a position of the buffers and counting the number of IP packets in each buffers to that point and particularly observing a particular value such as 50% of PBS such that it can be determined that the corrected frequency is higher or lower than the known source frequency whereby the frequency of streaming is indirectly provided by the observation.

The observation of the IP packets of the received transmitted sourced audio in the buffers of the plurality of receiving audio processors can be a direct frequency correction of the known source frequency. This direct frequency correction in one form can include monitoring a particular marking on the sourcing audio and maintaining observation of the frequency of observation of consecutive markings. The direct frequency correction can include timestamps included in received packets which delivers the information on departure times of packets such that the corresponding arrival time is measured with a receiver clock whose frequency is thereby directly determinable. It can include timestamps, but may also be done without using received packet timestamps and instead from measuring arrival time without timestamps.

The observation of the IP packets of the received transmitted sourced audio in the buffers of the plurality of receiving audio processors can be a combination of direct and indirect frequency correction of the known source frequency.

For emergency actions, watermarks can be created near the high and low end of the IP packet buffers, and if the number of IP packets is detected to be near the watermarks then a more severe emergency frequency correction is undertaken so as to allow for emergency recovery back to the predetermined correct position such as at 50% of PBS.

The invention provides a method of synchronized audio over a network wherein for minimising time variation, or drift over time of network packets at each receiver for uni-cast traffic and when there is no global clock in a network having multiple receivers, a round robin mode can be used which averages out delays related to the ordering and timing of transmitted packets and how network switches route these packets in hardware.

Packets can have specific destination Network addresses PD are sent by transmitter A through the Transmission Network to Receiver's C,D,E, up to receiver N each having their own destination Network address.

The packets can be addressed in the round robin order of:
a) First packet transmit interval Transmitter A sends duplicate (or related) audio content to each receiver in order C,D,E, . . . N
b) Second packet transmit interval Transmitter A sends duplicate (or related) audio content to each receiver in order D,E, . . . N,C,
c) Third packet transmit interval Transmitter A sends duplicate (or related) audio content to each receiver in order E, . . . N,C,D,
d) Fourth packet transmit interval Transmitter A sends duplicate (or related) audio content to each receiver in order N,C,D,E . . . then repeat.

Also when there is no global clock in a network having multiple receivers, a Ring Mode can is used separately or in combination wherein the timing of when each packet is transmitted is made more precise (and therefore reduces drift and timing variation in received packets) by staggering the sending time at equally spaced intervals per clock.

In another aspect of the invention the method of synchronized audio over an audio data transmission network can be achieved without a global clock by a time correction of audio in transmissible packets including the steps of:
a) transmitting the IP packets of source audio at a regular and accurate packet rate (PR) which is related to the audio input clock rate (SR).
b) propagating the IP packets through the network to the receiver (RX).
c) Processing the transmitted source audio in the IP packets at the receiver at the same rate as the audio input clock rate (SR).
d) Observing the IP packets of the received transmitted source audio in the buffer to determine the variance of the actual received clock rate
e) Outputting the IP packets audio packets at the determined adjusting clock rate based on the determined variance of the actual received clock rate of receiver processing audio to match clock rate of audio at originating audio processor as represented by the determined transmitted frequency
wherein the endpoint processing of processing audio is synchronised without a global clock.

In another aspect of the invention the method of synchronized audio over an audio data transmission network can be achieved without a global clock by a time correction of audio in transmissible packets including the steps of:
a) transmitting the IP packets of source audio at a regular and accurate packet rate (PR) which is related to the audio input clock rate (SR).
b) propagating the IP packets through the network to a plurality of receivers (RX) in such a way that, the order of the plurality of receivers which will first receive a certain IP packet will change in a round robin manner, (by method of the transmitter changing which receiver to send to in a round robin manner) wherein the transmitter is accurate in timing each packet transmission to the plurality of receivers within a packet transmit interval.
c) Processing the transmitted source audio in each of the IP packets at the plurality of receivers at the same rate as the audio input clock rate (SR).
d) Observing each of the IP packets of the received transmitted source audio in each the buffers to determine the variance of the actual received clock rates
e) Outputting each of the IP packets audio packets at the determined adjusting clock rate based on the determined variance of the actual received clock rates of the plurality of receiver processing audio to match clock rate of audio at originating audio processor as represented by the determined transmitted frequency
wherein the endpoint processing of processing audio is synchronised without a global clock.

It can be seen that the invention of a method of synchronized audio over a network provides the benefit of it being possible to transmit high and ultra-high resolution audio across a network without the use of global clocking. Sending packets of audio over a network in real time requires the audio clock to be recovered at the receiving side.

Bound by real-world constraints (100M or 1G, 5G or 10G wired-ethernet, 8 channel 192 kHz audio, latency <10 mS), it is possible to overcome the requirement for global clocking by recovering the clocking information from audio data itself.

Achieving this is a major breakthrough.

Developing in this area does not require any complex global network synchronization mechanisms but now enables a multitude of use cases which were not possible with existing standards.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is an example of different input audio streaming options for transmission over WiFi or Ethernet to various self-contained audio systems that are enabled without complex structures by use of the novel asynchronous clock reconstruction from sourcing audio in accordance with the present invention;

FIG. 2 is a diagrammatic view of the address connections through an address transmission network for unicast transmission sync optimization connection;

FIG. 3 is a diagrammatic view of the Unicast transmission sync optimization transmitter schemes related to the connections shown in FIG. 2;

FIG. 4 is a diagrammatic view of an embodiment of the novel asynchronous clock reconstruction from sourcing audio in accordance with the present invention;

FIG. 5 is a detail of the shaded section of FIG. 4;

FIG. 6 shows the two way actions of the audio inputs and returning auxiliary audio outputs that use opposing steps of the same novel asynchronous clock reconstruction from sourcing audio in accordance with the present invention;

FIG. 7 is a test structure for performing a simulated synchronized audio of the invention of FIGS. 4, 5 and 6 as a network asynchronous clock reconstruction from sourcing audio;

FIG. 8 is a measured output showing low jitter rate control output of the resultant effect of the simulation of FIG. 7;

FIGS. 9 and 10 are explanatory diagrammatic block diagrams of the steps in a method of streaming synchronized audio over a network using asynchronous clock reconstruction from the sourcing audio in accordance with embodiments of the invention.

### DESCRIPTION OF PREFERRED EMBODIMENTS

It should be noted in the following description that like or the same reference numerals in different embodiments denote the same or similar features.

Referring to the drawings there is shown an asynchronous clock reconstruction from audio sources. In one form the method uses source clock frequency recovery (SCFR) in packet networks.

### Transmission

In order to recover the source clock frequency without a common reference clock or any reference period in packet streams, transmitter TX receives audio from the audio inputs and prepares the next IP packet of audio to be streamed. The IP packets are transmitted using UDP protocol (and UDP packet may be further wrapped inside RTP header). Each IP packet contains both a header (which can be of 20 or 24 bytes long) and data (variable length). The header includes the IP addresses of the source and destination, plus other fields that help to route the packet. The audio data is the actual IP packet content (also known as the payload).

The transmitter sends the IP packets at a regular and accurate packet rate (PR) which is related to the audio input clock rate (SR).

It should be noted that the UDP packet may be sent by many means such as (but not limited to) Unicast and Multicast methods.

The IP packets propagate through the network to the receiver (RX).

At the receiver the IP packets are processed at the same rate (SR).

The output sample rate to the outputs of speakers or other self-contained audio systems such as a multichannel Digital Signal Processor (DSP) Amplifiers, networked audio receivers and stereo amplifier receivers feeding to own speaker network.

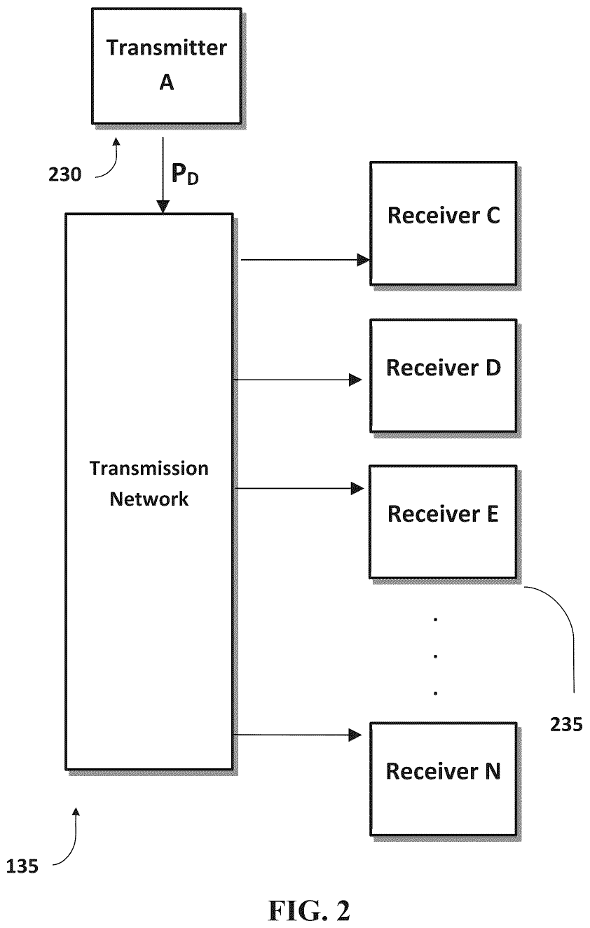

In another embodiment of the invention as shown in FIG. 2, in order to recover the source clock frequency without a common reference clock or any reference period in packet streams, transmitter 230 TX receives audio from the audio inputs and prepares the next IP packet of audio to be streamed. The IP packets are transmitted using UDP protocol (and UDP packet may be further wrapped inside RTP header). Each IP packet contains both a header (which can be of 20 or 24 bytes long) and data (variable length). The header includes the IP addresses of the source and destination, plus other fields that help to route the packet. The audio data is the actual IP packet content (also known as the payload).

The transmitter 230 sends the IP packets at a regular and accurate packet rate (PR) which is related to the audio input clock rate (SR).

The IP packets propagate through the network 135 to a plurality of receivers 235 in such a way that, the sequence of the plurality of receivers receiving the IP packets changes in a cyclical order per IP packet until the last IP packet has been distributed.

At the plurality of receivers the IP packets are processed at the same rate (SR).

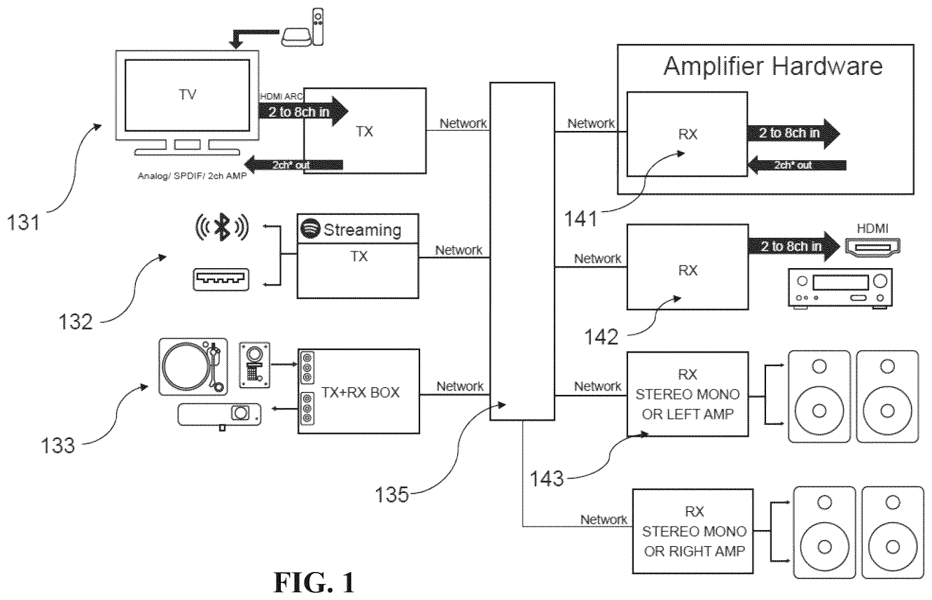

For distributed multi-channel applications (such as a single receiver at each of many speakers) one IP packet containing multiple audio channels may be transmitted to multiple receivers, with each receiver selecting one or more channels to output from the received packet. While not limited to two channel and as shown in FIG. 1. 143 this is especially useful when multiple speakers each with a receiver then output only the left, right, rear left, rear right, center or sub channel from the received IP packet.

The output sample rate to the outputs of speakers or other self-contained audio systems such as a multichannel Digital Signal Processor (DSP) Amplifiers, networked audio receivers and stereo amplifier receivers feeding to own speaker network.

### Unicast Transmission Sync Optimisation

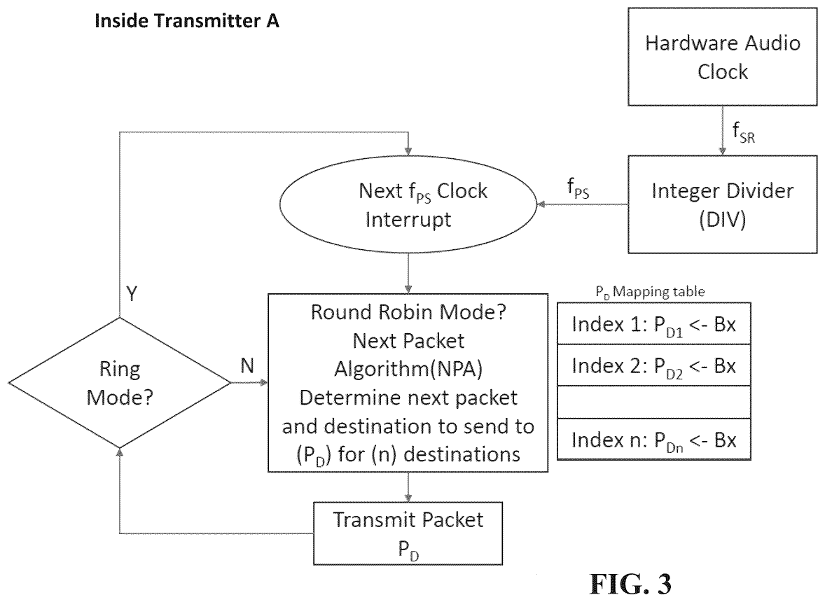

Referring to FIGS. 2 and 3, for uni-cast traffic and when there is no global clock in a network then multiple receivers that receive network streams (containing audio packets) from a single transmitter have audio playback rates that are largely dependent on the arrival time of the network packets at each receiver. This arrival time can vary for various reasons (such as network switch buffering and topology) and can result in drift or delay changes over time between receivers. Furthermore, any timing variation of the exact time that each packet is sent from the transmitter will also result in timing variations of when each packet arrives at each receiver. Minimising this time variation, or drift over time, is important to ensure synchronisation accuracy and avoid audio artifacts such as phasing, nulling or distortion.

To minimise this time variation two schemes are presented. Round Robin Mode and Ring Mode. Both modes can be used together or separately. In all cases DMA, zero copy techniques and priority to real-time audio processing are employed in hardware processing. To minimise time variation and drift a round-robin transmission scheme is used.

The round-robin approach averages out delays related to the ordering and timing of transmitted packets and how network switches route these packets in hardware. The result is lower drift and variance over time between receivers. In the case where transmitter A sends the same (or different) audio buffer content to more than one receiver at the same time: Transmitter A is sending packets at regular rate (packet transmit interval) related to the sample rate of the audio input. The order the packets are sent is changed in round-robin packet transmit interval. Refer to Next Packet Algorithm (NPA) for detail of how this works in practice.

Further more for Ring Mode the timing of when each packet is transmitted can be made more precise (and therefore reduce drift and timing variation in received packets) by staggering the sending time at equally spaced intervals per clock.

Refer to Next Packet Algorithm (NPA) for detail of how this works in practice.

Packets with specific destination Network addresses (IP/MAC addresses) P(subscript D) are sent by transmitter A (230) through the Transmission Network (135) to Receiver's C,D,E, up to receiver N (135) each having their own destination Network address

By way of example:
a) First packet transmit interval Transmitter A sends duplicate (or related) audio content to each receiver in order C,D,E, . . . N
b) Second packet transmit interval Transmitter A sends duplicate (or related) audio content to each receiver in order D,E, . . . N,C,
c) Third packet transmit interval Transmitter A sends duplicate (or related) audio content to each receiver in order E, . . . N,C,D,
d) Fourth packet transmit interval Transmitter A sends duplicate (or related) audio content to each receiver in order N,C,D,E . . . then repeat.

In this scheme the transmitter device should be accurate in its timing of each packet transmission (to multiple receivers) within the packet transmit interval so as to avoid contributing to receiver drift. Techniques should be used in the transmitting device to minimise this, such as; packet construction, duplication and buffering in hardware, interrupt driven dma transfers of the packet data and equally spaced timing of the transmission of each packet within the packet transmit interval.

In an example, but not limited to, the method of sending the IP packet from a transmitter to a plurality of receivers 235 is:
Sending of a first IP packet from a transmitter 230 at a regular and accurate packet rate (PR) which is related to the audio input clock rate (SR);
   Propagating of the first IP packet through the network 135;
   Receiving at a receiver C of the first IP packet;
   Receiving at a receiver D of the first IP packet;
   Receiving at a receiver E of the first IP packet;
   And Receiving at subsequent receivers of the first IP packet;
   Until Receiving at receiver N of the first IP packet;
Sending of a second IP packet from the transmitter at a regular and accurate PR which is related to the SR;
   Propagating of the second IP packet through the network;
   Receiving at receiver D of the second IP packet;
   Receiving at receiver E of the second IP packet;
   Receiving at subsequent receivers of the second IP packet;
   Until Receiving at receiver N of the second IP packet;
   Receiving at receiver C of the second IP packet;
Sending of a third IP packet from the transmitter at a regular and accurate packet rate (PR) which is related to the audio input clock rate (SR);
   Propagating of the third IP packet through the network;
   Receiving at receiver E of the third IP packet;
   Receiving at the subsequent receivers of the third IP packet;
   Up to Receiving at receiver N of the third IP packet;
   Receiving at receiver C of the third IP packet;
   Receiving of receiver D of the third IP packet;
Sending of a fourth IP packet from the transmitter at a regular and accurate packet rate (PR) which is related to the audio input clock rate (SR);
   Receiving of the subsequent receivier of the fourth IP packet;
   Receiving of receiver N of the fourth IP packet;
   Receiving of receiver C of the fourth IP packet;
   Receiving of receiver D of the fourth IP packet;
   Receiving of receiver E of the fourth IP packet;
Sending of a fifth IP packet from the transmitter at a regular and accurate packet rate (PR) which is related to the audio input clock rate (SR);
   Receiving of receiver N of the fifth IP packet;
   Receiving of receiver C of the fifth IP packet;
   Receiving of receiver D of the fifth IP packet;
   Receiving of receiver E of the fifth IP packet;
   Receiving of the subsequent receiver of the fifth IP packet; and
Repeating of the foregoing methods while the sequence of the plurality of receivers receiving the IP packets changes in a cyclical order per IP packet distributed until the last IP packet has been distributed;wherein the number of receivers is not limited to the foregoing examples, and that the subsequent receiver represents a number of receivers that may be added in to the plurality of receivers.

As enumerated in the embodiment above, sending of certain packet from the transmitter 230 at a regular and accurate packet rate which is related to the audio input clock rate makes it possible so that synchronized audio can be stream over a network to a plurality of receivers without the use of a complex system or a single global audio clock. Once an IP packet has been propagated through the network 135, the plurality of receivers 235 will then receive the IP packet. When that IP packet has been distributed to the plurality of receivers, another IP packet will be sent by the transmitter to the network. Since there is only a single transmitter and plurality of receivers, the sequence of the plurality of receivers receiving the IP packets changes in a cyclical order per IP packet until the last IP packet has been distributed. It can be seen in the example above that the sequence of the plurality of receivers changes in cyclical order per IP packet distributed. The change of sequence in cyclical order allows the IP packets to be distributed to the plurality of receivers in equal manner to average out the delays relating to the ordering and timing of packets, resulting to a lower drift and variance between receivers. The steps are repeated until the last IP packet has been distributed.

### Next Packet Algorithm

Referring to FIG. 3, in the Next Packet Algorithm (NPA) the Next packet is determined from next index entry in table. Bx is audio buffer used for the packet P_{D}. Bx can be a single audio buffer to duplicate or multiple audio buffers.

The sample rate (SR) of the audio originating at the audio processor is substantially in the range of 32 kHz to 384 kHz. The hardware clock provides the frequency of the sample rate f_{SR} which is interval divided such the transmissible audio packets is an integer divided frequency of the sample rate (SR). For example a 48 Khz sample rate, the packet rate of the transmissible audio packets is used at 1.5 kHz, 3 kHz or 6 kHz or other integer division such as 750 Hz, 375 Hz etc.

The system uses a Round Robin Mode as detailed above and using this Next Packet Algorithm NPA so as to determine next packet and destination to send P_{D} for N destinations.

In Normal Mode, the Mapping table is fixed sequential mapping to each destination. Round Robin Mode: Mapping table changes (each table entry at index now becomes the entry at index+1, table wrapped about n) after the last Index n is transmitted.

In Ring Mode, when disabled then all (n) P_{D} destinations are sent as soon as possible per f_{PS} interrupt. When enabled then the next P_{D} is sent one per f_{PS} interrupt. f_{PS} rate shall be multiplied by n (DIV is divided by n).

### Frequency Correction

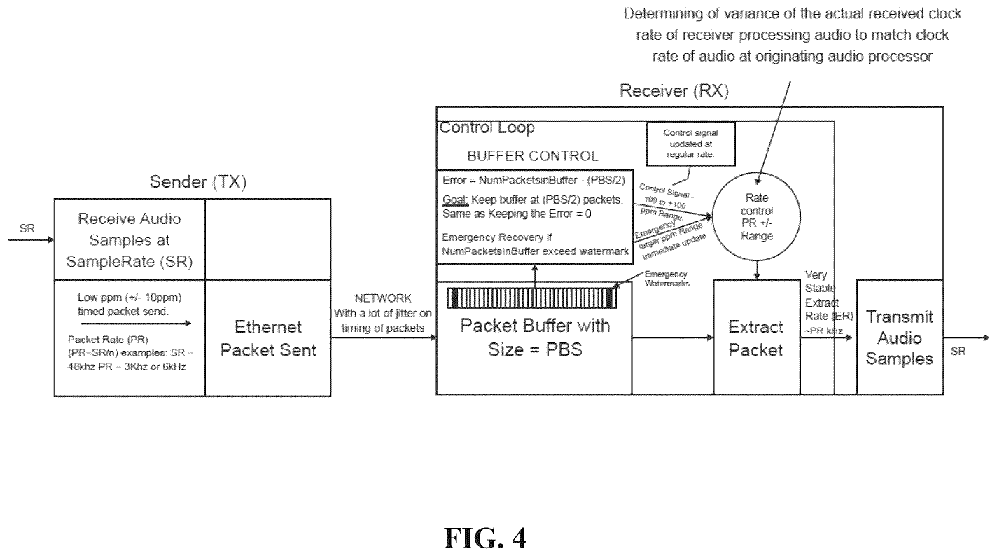

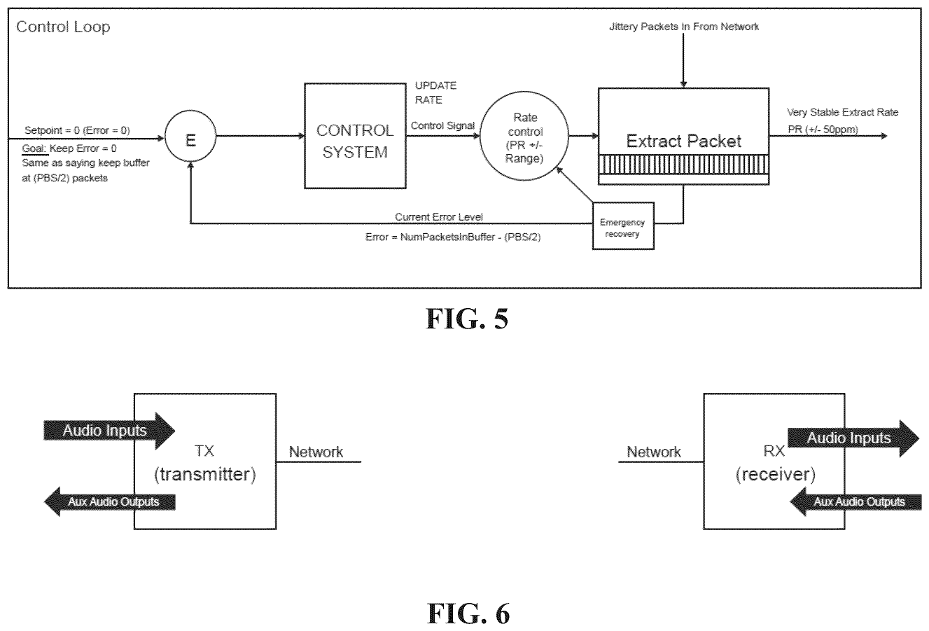

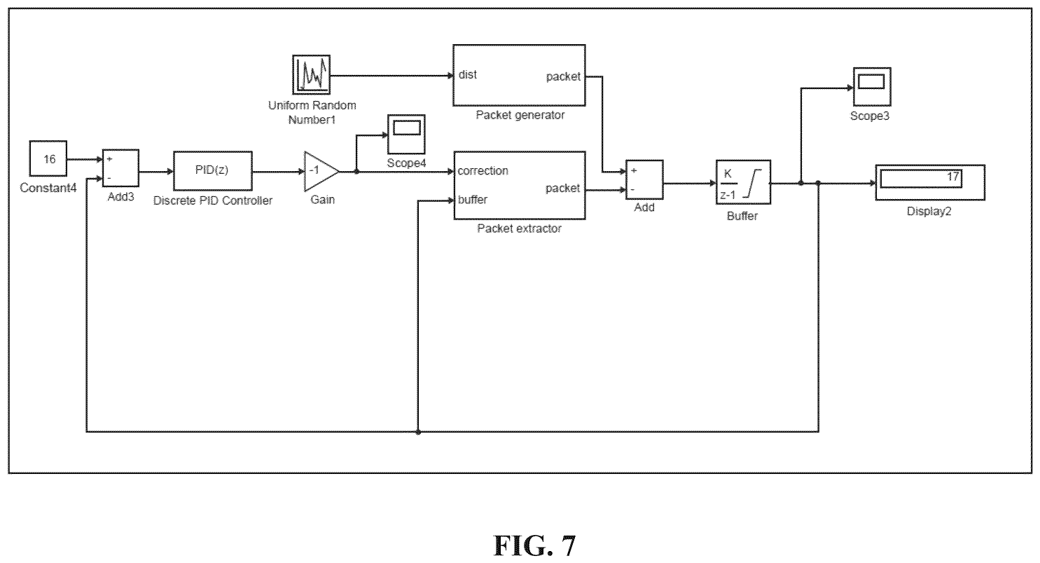

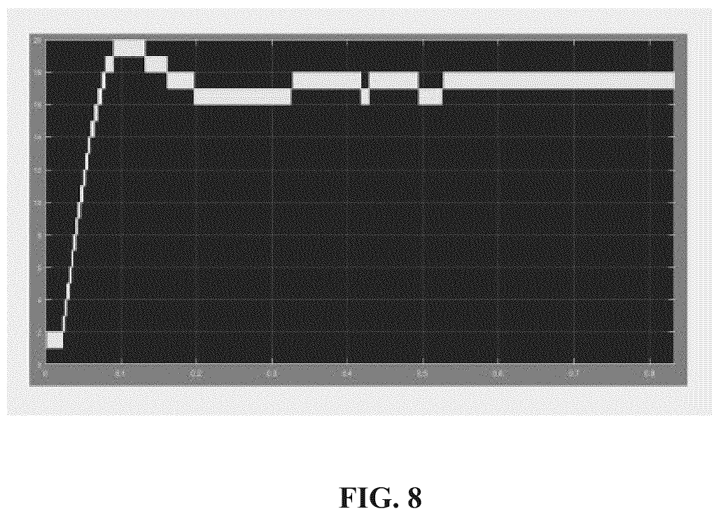

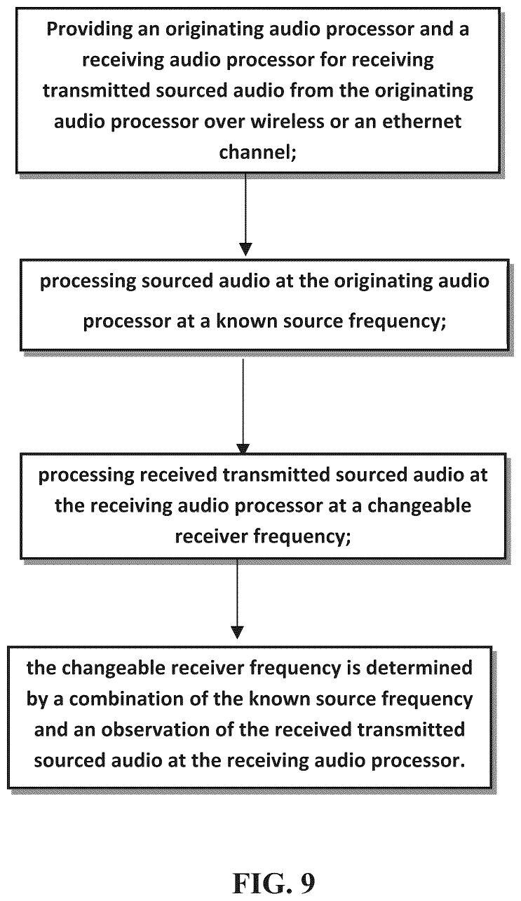

Referring to FIGS. 4 to 8, as the transmission causes fluctuations in rate of streaming including jitter on the timing of the packets, there is a need for frequency fluctuation. Instead of using a global clock, the method uses asynchronous clock reconstruction from the sourcing audio.

The clock reconstruction from the sourcing audio can be an indirect frequency correction such that a characteristic of the sourcing audio is observed over time to see fluctuations and thereby indirectly note the change of frequency by noting the change of characteristic of the streaming.

The source clock frequency recovery SCFR through periodic packet streams is a special case where the constant packet generation interval, assumed to be known at both the sender and the receiver through service specifications, can be used to extract this information instead of timestamps.

The clock reconstruction from the sourcing audio can be a direct frequency correction such that a predefined feature of the sourcing audio is marked and is directly observed over time at the receiver to thereby directly note the change of frequency by noting the predefined marked feature of the sourcing audio in the streaming.

### Indirect Frequency Correction—Buffer

As the IP packets are streamed and received by the receiver there is formed a buffer with a Packet Buffer Size (PBS). By observing a position of the buffer and counting the number of IP packets in the buffer to that point and particularly observing a particular value such as 50% of PBS then the frequency of streaming is indirectly provided by the observation.

It can be assessed if the streaming rate is ahead or behind of the known source frequency. The output frequency of the streaming audio can then be adjusted based on this observation of the PBS by adjusting the processing in the buffer rate to increase or decrease the number of IP packets in the buffer and return the observed point of 50% to match half the Packet Buffer Size (ie PBS/2).

This is the same as keeping the error at zero in a control loop. The control loop can consist of PID, PI, P controller architecture, or could consist of fixed rate changes above and below the 50% mark.

### Direct Frequency Correction—Timestamp

The IP Packets can be directly observed to determine frequency by monitoring a particular marking on the sourcing audio and maintaining observation of the frequency of observation of consecutive markings. In one form this is by use of a timestamp.

Timestamps are included in received packets which deliver the information on departure times of packets. A packet timestamp is generated by the source clock whose frequency is known. The corresponding arrival time is measured with a receiver clock whose frequency is known. The arrival time includes a packet delay measured in the receiver clock whose true value is unknown.

The arrival times, the timestamps, and the packet delays are modeled by linear regression where not only frequency ratio but also phase difference between the clocks are to be estimated. Because we need to estimate only the ratio for SCFR, a linear regression by subtracting initial values from arrival times, timestamps, and packet delays.

The output frequency (and phase relationship with source audio) can be directly altered to match the detected Direct Frequency Correction provided by the timestamp.

It can be understood that a combination of direct and indirect frequency correction methods can be used.

### Emergency Recovery

Referring to FIG. 4, emergency watermarks can be provided at the high and low position of the IP packets in the buffer for maximum or minimum required in the buffer. More severe adjustments of the direct frequency correction are needed if the observed number of IP packets is outside the limits of the maximum or minimum number of Packet Buffer Size (PBS). If this occurs then clearly processing faults will result in failure of correct audio streaming and jumping or deletion of sections of audio source in the outputted audio.

The watermarks are created near the high and low end of the IP packet buffer, as shown in FIG. 4. If detection of the number of IP packets is detected to be near the watermarks then a more severe emergency frequency correction is undertaken so as to allow for emergency recovery back to the predetermined correct position such as at 50% of PBS.

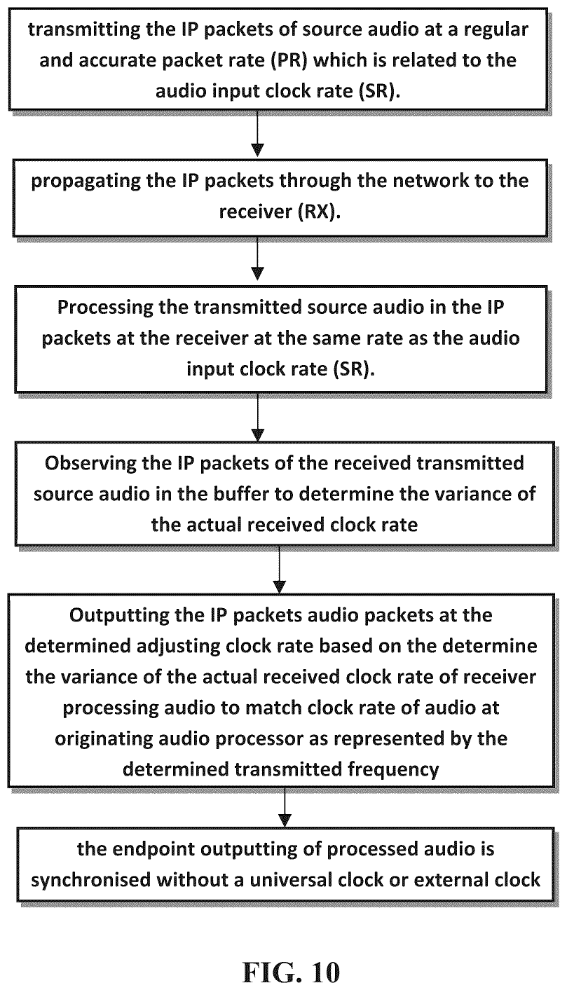

Referring to FIG. 9, the invention provides a method of streaming synchronized audio over a network using asynchronous clock reconstruction from the sourcing audio including the steps of:
a) An originating audio processor and a plurality of receiving audio processors for receiving transmitted sourced audio from the originating audio processor over an audio data transmission channel;
b) processing sourced audio at the originating audio processor at a known source frequency;
c) processing the plurality of received transmitted sourced audio at the plurality of receiving audio processors at a changeable receive frequency;
d) wherein the changeable receiver frequency is determined by a combination of the known source frequency and an observation of the plurality of received transmitted sourced audio at the plurality of receiving audio processors.

The audio transmission channel is a wireless or an ethernet channel, wherein the processing received transmitted sourced audio is transmittable to a plurality of audio outputting means at a changeable receiver frequency. The changeable receiver frequency is determined from the known source frequency and an observation of the IP packets of the plurality of received transmitted sourced audio in a plurality of buffers of the plurality of receiving audio processors.

Referring to FIG. 10 There is provided a method of synchronized audio over an audio transmission network wherein synchronisation is achieved without a global clock by the time correction of audio in transmissible packets including the steps of:
a) transmitting the IP packets of source audio at a regular and accurate packet rate (PR) which is related to the audio input clock rate (SR);
b) propagating the IP packets through the network to a plurality of receivers in such a way that, the sequence of the plurality of receivers receiving the IP packets changes in a cyclical order per IP packet until the last IP packet has been distributed;
c) processing the transmitted source audio in the IP packets at the plurality of receivers at the same rate as the audio input clock rate (SR);
d) observing the IP packets of the received transmitted source audio in the plurality of buffers to determine the variance of the actual received clock rate;
e) Outputting of the IP packets audio packets at the determined adjusting clock rate based on the determined variance of the actual received clock rate of the plurality of receiver processing audio to match clock rate of audio at originating audio processor as represented by the determined transmitted frequency.

The predefined input framework includes one or more categories of networked receiver/transmission audio devices selected from:
television;
streaming channel;
real time sources such as intercom and microphone inputs;
streamings playable on record players, CD players or radios;
a multichannel DSP amplifiers;
networked audio receivers; and
stereo amplifier receivers feeding to own speaker network.

The transmission is through WiFi or Ethernet Network.

Other variations understood by a person skilled in the art are included within the scope of this invention.

### INTERPRETATION

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the audio streaming industries.

What is claimed is:

1. A method of synchronized audio over a network using asynchronous clock reconstruction from audio sources including the steps of:
a. an audio data transmission channel between an originating audio processor and a receiving audio processor;
b. a rate control of the audio data transmission channel providing a time correction to enable clock synchronisation of the processing of the audio on the originating audio processor with the audio on the receiving audio processor;
c. processing received transmitted sourced audio at the receiving audio processor at a changeable receiver frequency;
d. wherein the changeable receiver frequency is determined by a combination of the known source frequency and an observation of the received transmitted sourced audio at the receiving audio processor.

2. A method of synchronized audio over a network according to claim 1 wherein the audio data transmission channel is a wireless or an ethernet channel;
wherein the processing received transmitted sourced audio is transmittable to an audio outputting means at the changeable receiver frequency;
wherein the changeable receiver frequency is determined from the known source frequency and an observation of the IP packets of the received transmitted sourced audio in the buffer of the receiving audio processor;
and wherein the observation of the IP packets of the received transmitted sourced audio in the buffer of the receiving audio processor is an indirect frequency correction of the known source frequency.

3. A method of synchronized audio over a network according to claim 2 wherein the indirect frequency correction includes observing a position of the buffer and counting the number of IP packets in the buffer to that point and particularly observing a particular value such as 50% of the size of PBS (Packet Buffer with Size) such that it can be determined that the corrected frequency is higher or lower than the known source frequency whereby the frequency of streaming is indirectly provided by the observation;
wherein the observation of the IP packets of the received transmitted sourced audio in the buffer of the receiving audio processor is a direct frequency correction of the known source frequency;
wherein the direct frequency correction includes monitoring a particular marking on the sourcing audio and maintaining observation of the frequency of observation of consecutive markings;
wherein the direct frequency correction includes timestamps included in received packets which delivers the information on departure times of packets such that the corresponding arrival time is measured with a receiver clock whose frequency is thereby directly determinable;
wherein the observation of the IP packets of the received transmitted sourced audio in the buffer of the receiving audio processor is a combination of direct and indirect frequency correction of the known source frequency.

4. A method of synchronized audio over a network according to claim 2 wherein watermarks are created near the high and low end of the IP packet buffer, and if the number of IP packets is detected to be near the watermarks then a more severe emergency frequency correction is undertaken so as to allow for emergency recovery back to the predetermined correct position such as at 50% of PBS.

5. A method of synchronized audio over a network according to claim 1 wherein for minimising time variation, or drift over time of network packets at each receiver for uni-cast traffic and when there is no global clock in a network having multiple receivers, a round robin mode can be used which averages out delays related to the ordering and timing of transmitted packets and how network switches route these packets in hardware.

6. A method of synchronized audio over a network according to claim 5 wherein packets with specific destination Network addresses PD are sent by transmitter A through the Transmission Network to Receiver's C,D,E, up to receiver N each having their own destination Network address.

7. A method of synchronized audio over a network according to claim 6 wherein
a. First packet transmit interval Transmitter A sends duplicate (or related) audio content to each receiver in order C,D,E, . . . N;
b. Second packet transmit interval Transmitter A sends duplicate (or related) audio content to each receiver in order D,E, . . . N,C;
c Third packet transmit interval Transmitter A sends duplicate (or related) audio content to each receiver in order E, . . . N,C,D; and
d. Fourth packet transmit interval Transmitter A sends duplicate (or related) audio content to each receiver in order N,C,D,E . . . then repeat.

8. A method of synchronized audio over a network according to claim 1 wherein for minimising time variation, or drift over time of network packets at each receiver for uni-cast traffic and when there is no global clock in a network having multiple receivers, a Ring Mode is used wherein the timing of when each packet is transmitted is made more precise (and therefore reduces drift and timing variation in received packets) by staggering the sending time at equally spaced intervals per clock.

9. A method of synchronized audio over an audio data transmission network wherein synchronisation is achieved without a global clock by the time correction of audio in transmissible packets including the steps of:
a. transmitting the IP packets of source audio at a regular and accurate packet rate (PR) which is related to the audio input clock rate (SR);
b. propagating the IP packets through the network to the receiver (RX);
c. processing the transmitted source audio in the IP packets at the receiver at the same rate as the audio input clock rate (SR);
d. observing the IP packets of the received transmitted source audio in the buffer to determine the variance of the actual received clock rate; and
e. outputting the IP packets audio packets at the determined adjusting clock rate based on the determined variance of the actual received clock rate of receiver processing audio to match clock rate of audio at originating audio processor as represented by the determined transmitted frequency.

10. A method of synchronized audio over a network according to claim 9 wherein the predefined input framework includes one or more categories of networked receiver/transmission audio devices selected from:
a. a television;
b. a streaming channel;
c. real time sources such as intercom and microphone inputs;
d. streamings playable on record players, CD players or radios;
e. a multichannel Digital Signal Processor (DSP) Amplifiers;
f. networked audio receivers;
g stereo amplifier receivers feeding to own speaker network.

11. A method of synchronized audio over a network according to claim 9 wherein the transmission is through WiFi or Ethernet Network.

12. A method of synchronized audio over a network according to claim 9 wherein measured frequency is maintained substantially around half packet buffer size.

13. A method of synchronized audio over a network according to claim 9 wherein emergency correction occurs if the observed number of audio packets in buffer is near the spaced watermarks at high/low ends of the required number of the transmissible audio packets in the buffer.

14. A method of synchronized audio over a network according to claim 9 wherein if detection of the number of audio packets in buffer exceeds or nears the limits of the spaced watermarks on the transmissible audio packets an emergency rate is used to provide an emergency correction.

15. A method of synchronized audio over a network according to claim 9 wherein the sample rate (SR) of the audio originating at the audio processor is substantially in the range of 32 kHz to 384 kHz.

16. A method of synchronized audio over a network according to claim 12 wherein the packet rate (PR) of the transmissible audio packets is an integer divided frequency of the sample rate (SR); and wherein for a 48 Khz sample rate (SR), the packet rate (PR) of the transmissible audio packets is used at 1.5 kHz, 3 kHz or 6 kHz or other integer division such as 750 Hz, 375 Hz etc.

17. A method of synchronized audio over an audio transmission network wherein synchronisation is achieved without a global clock by the time correction of audio in transmissible packets including the steps of:
a. transmitting the IP packets of source audio at a regular and accurate packet rate (PR) which is related to the audio input clock rate (SR);
b. propagating the IP packets through the network to a plurality of receivers in such a way that, the sequence of the plurality of receivers receiving the IP packets changes in a cyclical order per IP packet until the last IP packet has been distributed;
c. processing the transmitted source audio in the IP packets at the plurality of receivers at the same rate as the audio input clock rate (SR);
d. observing the IP packets of the received transmitted source audio in the plurality of buffers to determine the variance of the actual received clock rate; and
e. outputting the IP packets audio packets at the determined adjusting clock rate based on the determined variance of the actual received clock rate of the plurality of receiver processing audio to match clock rate of audio at originating audio processor as represented by the determined transmitted frequency.

18. A method of synchronized audio over a network according to claim 17 wherein the predefined input framework includes one or more categories of networked receiver/transmission audio devices selected from:
a. television;
b. streaming channel;
c. real time sources such as intercom and microphone inputs;
d. streamings playable on record players, CD players or radios;
e. a multichannel DSP amplifiers;
f. networked audio receivers; and
g. stereo amplifier receivers feeding to own speaker network.

19. A method of synchronized audio over a network according to claim 17 wherein the transmission is through WiFi or Ethernet Network.

20. A method of synchronized audio over a network according to claim 17 wherein measured frequency is maintained substantially around half packet buffer size.

21. A method of synchronized audio over a network according to claim 17 wherein emergency correction occurs if the observed number of audio packets in the plurality of buffers is near the spaced watermarks at high/low ends of the required number of the transmissible audio packets in the buffer.

22. A method of synchronized audio over a network according to claim 17 wherein if detection of the number of audio packets in the plurality of buffers exceeds or nears the limits of the spaced watermarks on the transmissible audio packets an emergency rate is used to provide an emergency correction.

23. A method of synchronized audio over a network according to claim 17 wherein the sample rate (SR) of the audio originating at the audio processor is substantially in the range of 32 kHz to 384 kHz;
wherein the packet rate (PR) of the transmissible audio packets is an integer divided frequency of the sample rate (SR); and
wherein for a 48 Khz sample rate, the packet rate of the transmissible audio packets is used at 1.5 kHz, 3 kHz or 6 kHz or other integer division such as 750 Hz, 375 Hz etc.
